(19) United States
(12) Patent Application Publication
(10) Pub. No.: US 2024/0267482 A1
(43) Pub. Date: Aug. 8, 2024

(54) DEVICE, IN PARTICULAR MOBILE DEVICE, FOR USE WITH A CAMERA, AND SYSTEMS AND METHODS FOR TRANSFERRING OR PROCESSING CAMERA DATA

(71) Applicant: Aleksandar Ristic, München (DE)

(72) Inventor: Aleksandar Ristic, München (DE)

(21) Appl. No.: 18/564,936

(22) PCT Filed: May 30, 2022
(86) PCT No.: PCT/EP2022/064531

§ 371 Date: Nov. 28, 2023

(30) Foreign Application Priority Data
May 28, 2021 (DE) 10 2021 002 776.0

(51) Int. Cl. H04N 5/268; H04N 5/91; H04N 23/661

(52) U.S. Cl. CPC H04N 5/268; H04N 5/91; H04N 23/661

(57) ABSTRACT

The invention relates to a mobile device or mobile appliance for use with a camera, and systems and methods for transferring or processing camera data. According to one aspect, a system for transferring or processing camera data is provided which has: a camera for recording image data and a mobile device or mobile appliance which can communicate with the camera wirelessly or by wire for forwarding the image data to the Internet. The mobile appliance can be advantageously designed and configured such that the image data can be forwarded by the mobile appliance to social networks, in particular in real time. In addition, the mobile appliance can be advantageously designed and configured such that it can be used to control one or more functions of the camera.

### CROSS-REFERENCE TO RELATED APPLICATION(S)

This application is a U.S. National Stage Application of PCT International Application No. PCT/EP2022/064531, filed on May 30, 2022, which claims priority to the German Patent Application No. 10 2021 002 776.0, filed on May 28, 2021, which are incorporated herein by reference in their entireties.

### BACKGROUND OF THE INVENTION

The invention relates to a device for use with a camera, in particular a mobile device or a mobile appliance for use with a video camera, and to systems and methods for transferring or processing camera data, in particular camera data recorded by a video camera.

### SUMMARY OF THE INVENTION

Video cameras are devices for recording images, in particular for recording moving images, and their continuous conversion into electric signals.

In a wider sense, digital cameras may also be referred to as “video cameras”.

For recording a sound, a microphone may be integrated into a video camera. Alternatively or additionally, a video camera may comprise one or a plurality of connections which may be connected to appropriate microphones.

Alternatively or additionally, a video recorder may also be integrated into a video camera; such video camera is often referred to as a “camcorder”.

Appropriate GPS receivers of GPS systems are integrated into some of the video cameras available in the market.

GPS/Global Positioning Systems are, for instance, based on satellites which permanently emit their current position and/or the exact time with encoded radio signals. From the signal propagation delay or the time GPS receivers may then calculate, for instance, their own position and/or speed, and/or their direction of movement, and/or the exact time in the GPS receiver, etc.

Furthermore, many video cameras have a display by means of which the moving images/videos recorded may be watched.

For the recording of action scenes—for instance, during skiing, snowboarding, bicycling, mountain biking, surfing, wind surfing, water skiing, kiting, motor boating, sailing, flying, parapenting, bungee jumping, base jumping, hang gliding, paragliding, parachuting, car driving, motor biking, etc., etc.—as small and light-weight cameras as possible are used.

Frequently, such video cameras are not hand-held during recording, but, for instance, fastened to the head, to the body, to a helmet, to the clothing, etc. of the respective user.

However, the handling or operating of many video cameras, for instance, for starting or stopping a recording, etc. is often not quite easy—in particular in the case of the relatively small video cameras used for the recording of action scenes due to the small camera dimensions.

This may be a problem in particular when recording action scenes where the user should give his/her attention to other matters than the handling or the operation of the video camera.

Furthermore, moving images/videos recorded by a video camera are shared more and more frequently on corresponding social networks or put on the Internet, for instance, in corresponding social networks or Internet platforms such as Youtube®, Facebook®, Instagram®, etc.

The desire of many users of video cameras is to share the recorded moving images /videos in a simple manner preferably directly or in real time on corresponding social networks, or to put them on the Internet preferably directly or in real time, and/or to edit them as “spectacularly” as possible.

Putting the recorded moving images/videos on the Internet, or sharing the recorded moving images/videos on corresponding social networks—directly or in real time—is, however, not or only in a relatively awkward manner possible with conventional video cameras.

This is, for instance, of great disadvantage especially for action scenes.

It is further desirable to edit the recorded moving images/videos as “spectacularly” as possible to make them as interesting as possible for users of the corresponding social networks. With conventional systems and methods for transferring or processing camera data this can often be done insufficiently only.

It is an object of the invention to provide a novel device for use with a camera, and novel systems and methods for transferring or processing camera data, in particular camera data recorded by a video camera, in particular a device or systems or methods by which the above-mentioned disadvantages of conventional devices or systems or methods can be overcome at least partially.

The invention achieves this and/or further objects by the subject matters of the independent claims.

Advantageous further developments of the invention are indicated in the subclaims.

The invention will now be explained in detail by means of several embodiments and the enclosed drawing. The drawing shows:

### BRIEF DESCRIPTION OF THE DRAWINGS

FIG. 1 a schematic exemplary illustration of a system for transferring or processing camera data in accordance with an embodiment of the present invention; and

FIG. 2 an exemplary illustration of a mobile device or a mobile appliance for use in a system or method for transferring or processing camera data, from several perspectives, in accordance with an embodiment of the present invention.

### DETAILED DESCRIPTION OF THE PREFERRED EMBODIMENTS

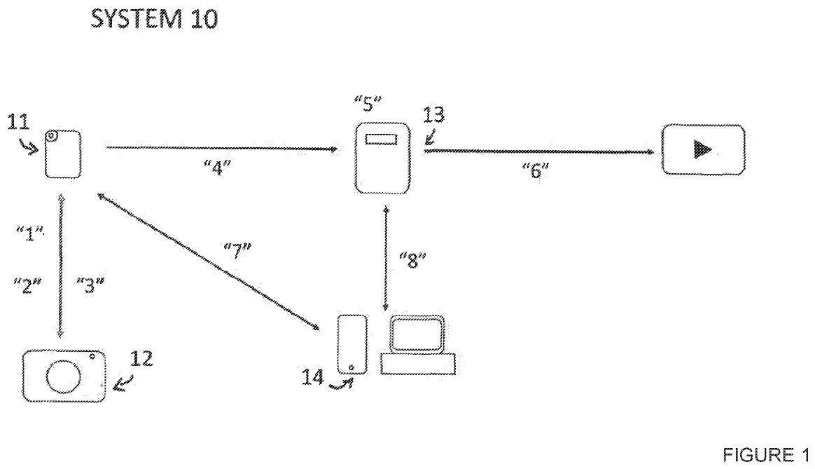

FIG. 1 shows schematically an exemplary illustration of a system 10 for transferring or processing camera data in accordance with an embodiment of the present invention.

The system 10 will be referred to in the following also as “LIVEDOCK system”.

LIVEDOCK system overview

The LIVEDOCK system 10 comprises:

a. a mobile appliance 11 (in the following also referred to as “LIVEDOCK” or “LIVEDOCK APPLIANCE”) which connects via WiFi and Bluetooth and/or cable with cameras 12 (cf. FIG. 1, reference number “1”) and offers users the possibility of transferring videos and images in real time (live) to the appliance 11 (cf. FIG. 1, reference number “3”) which then transmits the data to the Internet (social platforms, etc.) and to the server 13 via LTE (mobile radio) (cf. FIG. 1, reference number “4”).

The appliance 11 is water-tight and shock-proof. It may be used for sports and other activities where cameras 12 are used.

Additional sensors such as, for instance, GPS and/or acceleration sensors may be incorporated so as to register further data such as position and movement and integrate them into videos. Sensors may also be used to make decisions in a self-controlling manner, such as e.g. start/stop video transfer, slow motion, etc.

The appliance 11 may be fastened to the upper arm or to other positions such as bicycle handlebar, etc.

It is conceivable that an appliance 11 connects to a plurality of cameras 12 and controls them and also transfers the video data.

b. an application (in the following also referred to as “LIVEDOCK STUDIO”) for controlling and installing the appliance 11 and a back-end server 13 for storing and processing the video data (cf. FIG. 1, reference number “7”).

The application is used for controlling and installing the appliance 11. Furthermore, it may be used for processing the video data (LIVEDOCK STUDIO). By connecting with the back-end server 13, the application can call up a plurality of video data in real time and also at a later point in time (cf. FIG. 1, reference number “8”). With the application, a moderator can compile and moderate a “new” stream from various live transfers. For this purpose, he/she may add his/her own image and also sound for transferring.

The back-end server 13 stores (cf. FIG. 1, reference number “5”) and forwards videos to the application and further to the final destination, such as, for instance, to social networks (Facebook®, Youtube®, etc.) and to dedicated servers (cf. FIG. 1, reference number

### LIVEDOCK System Functions

The appliance 11 has the following functions:
1. It can start the recording of the camera (on internal storage medium) and the transferring via WiFi simultaneously (live mode) (cf. FIG. 1, reference number “2”)
2. It can start the recording of the camera only without WiFi transfer (remote control) (cf. FIG. 1, reference number “2”)
3. It can be used as a WiFi hotspot
4. Appliances can recognize each other and, for instance, index videos (time, position, etc.).

The application has the following functions:
1. Controlling one or a plurality of cameras 12
2. Administering the users
3. Accessing the back-end server 13 to represent videos in real time
4. Processing a plurality of videos in real time or at a later point of time
5. Adding sound and image to existing videos
6. Further functions for networking with other applications are conceivable

The back-end has the following functions:
1. Storing video data
2. Forwarding video data to the application in real time
3. Forwarding video data to Internet addresses and/or dedicated server
4. Connection to the application for controlling the functions and administration
5. The use of artificial intelligence is conceivable for processing video data and the transferring behavior

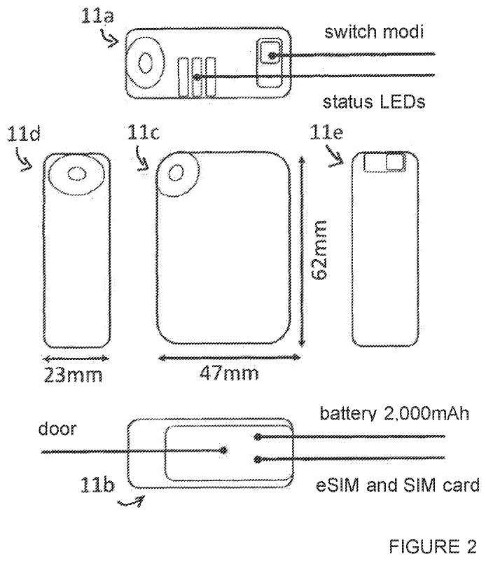

FIG. 2 schematically shows an exemplary detailed illustration of the mobile appliance 11 illustrated in FIG. 1 in accordance with an embodiment of the present invention from several perspectives, in particular from the top (cf. FIG. 2, reference number “11a”), from the bottom (cf. FIG. 2, reference number “11b”), from the side (cf. FIG. 2, reference number “11c”), from the left (cf. FIG. 2, reference number “11d”), and from the right (cf. FIG. 2, reference number “11e”).

Components of the LIVEDOCK appliance 11

The following components are incorporated in the device 11:
1. An exchangeable or firmly installed battery
2. PCBA with CPU
3. LTE chip
4. WiFi and Bluetooth chips (jointly or separated)
5. Various antennae
6. eSIM
7. SIM card slot
8. An on/off and check key (further keys are conceivable)
9. A switch for switching between various modi
10. A plurality of LEDs for indicating the current status and the connections
11. A display is conceivable to display data with respect to the appliance and the current application
12. Further sensors are conceivable

The mobile appliance 11 advantageously has only relatively small dimensions, for instance, a length of less than 18 cm or 14 cm, in particular, for instance, less than 10 cm or 7 cm (in the present embodiment e.g. 47 mm) and/or a height, for instance, of less than 20 cm or 16 cm, in particular, for instance, of less than 12 cm or 9 cm (in the present embodiment e.g. 62 mm) and/or a breadth, for instance, of less than 7 cm or 5 cm, in particular, for instance, less than 4 cm or 3 cm (in the present embodiment e.g. 23 mm).

In a particularly advantageous manner the mobile appliance 11 can be used—along with the camera 12—when recording or transferring action scenes—for instance, during skiing, snowboarding, bicycling, mountain biking, surfing, wind surfing, water skiing, kiting, motor boating, sailing, flying, parapenting, bungee jumping, base jumping, hang gliding, paragliding, parachuting, car driving, motor biking, etc., etc. (or when transferring the moving images/videos recorded by the camera 12—in particular during action scenes—to corresponding social networks such as Youtube®, Facebook®, Instagram®, etc., in particular, for instance, directly or in real time, so that the moving images recorded by the camera 12 can—by interposition of the mobile appliance 11—be shared in the corresponding social networks or be put on the Internet, for instance, directly or in real time (e.g. with Youtube®, Facebook®, Instagram®, etc.)).

During recording or transferring the appliance 11 may, for instance, be held in the hand of the respective user. In a particularly advantageous manner, however, the appliance is not hand-held during recording or transferring, but is, for instance, fastened to a helmet of the user or, for instance, to the clothing of the user (e.g. to the jacket, to the shirt, to the pullover, to the T-shirt, to the cap, etc.), to the body of the user (e.g. to the arm, in particular the upper arm, to the leg, to the neck, to the breast, to the head, etc.) or to the respective (sports) equipment used by the respective user for the action scene (e.g. to the bicycle, in particular, for instance, to the bicycle handlebar, to the ski, snow board, ski pole or snow board pole, surfing appliance, kite, boat, aircraft (airplane, glider, parapenter, parachute, paraglider, kite, balloon, etc.), vehicle, motorbike, etc.).

The video camera 12 may—similar to the mobile appliance 11—advantageously also have relatively small dimensions, for instance, a length of less than 18 cm or 14 cm, in particular less than 10 cm or 8 cm, and/or a height and/or breadth of less than 7 cm or 5 cm, in particular less than 3 cm.

During recording the video camera 12 may be hand-held by the respective user, or advantageously be fastened to a helmet of the user (“helmet camera”) instead, or, for instance, to his/her clothing (e.g. to the jacket, to the shirt, to the pullover, to the T-shirt, to the cap), to his/her body (e.g. to the arm, in particular upper arm, to the leg, to the neck, to the breast, to the head, etc.).

Alternatively, the video camera 2 may also be fastened to the respective (sports) equipment used for the action scene by the respective user, for instance, ski, snowboard, ski pole or snowboard pole, bicycle, in particular bicycle handlebar, surf appliance, kite, boat, aircraft (airplane, glider, parapenter, parachute, paraglider, kite, balloon, etc.), vehicle, motor bike, etc.

The video camera 12 may, for instance, comprise a display by which the moving images/videos recorded by the video camera can be watched as required—during and/or after recording. Alternatively—for instance to keep the dimensions of the camera 12 small—a video camera 12 without a display may also be used.

By means of the video camera 2 images, in particular moving images, can be recorded.

Advantageously, the moving image data recorded by the video camera 12 may be subjected by the camera 12 to an appropriate compression, for instance, by using a JPEG or MPEG, in particular e.g. a H.264/H.263/H.262 video data compression method, or any other compression method, in particular a method fulfilling an appropriate standard.

In a particularly advantageous use of the system 10—in particular in the case of an action scene—the respective user of the mobile appliance 11 can—by onetime actuating of a single operating element on the device 11, in particular by onetime actuating of a single check key, e.g. a single start/stop knob of the appliance 11—automatically start simultaneously both the recording of moving images by the camera 12 and also automatically the transferring of the recorded moving images from the camera 12 to the appliance 11, and from there on to corresponding social networks, such as Youtube®, Facebook®, Instagram®, etc., in particular, for instance, directly or in real time.

For this purpose, by actuating the above-mentioned check key, e.g. the start/stop knob of the appliance 11, the appliance 11 may automatically initiate that the appliance 11 sends—e.g. via Bluetooth or WiFi—an appropriate “start recording signal” to the camera 12.

On receipt of this “start recording signal” by the camera 12 it automatically initiates the start of the recording of moving images and the transferring of the recorded moving images from the camera 12 to the appliance 11 (e.g. via Bluetooth or WiFi).

On receipt of the recorded moving images by the appliance 11 (or initiated by the onetime actuating of the above-mentioned check key, e.g. the start/stop knob of the appliance 11) the appliance 11 can automatically initiate the transferring of the recorded moving images received by the camera 12 to corresponding social networks such as Youtube®, Facebook®, Instagram®, etc., in particular, for instance, directly or in real time.

This may, for instance, be achieved in that the appliance 11 automatically (or initiated by the above-mentioned onetime actuating of the above-mentioned check key, e.g. the start/stop knob of the appliance 11) transfers the recorded moving images via the above-mentioned servers 13, e.g. the above-mentioned back-end server or any further computers or servers, to the corresponding social networks such as Youtube®, Facebook®, Instagram®,.

Alternatively, the appliance 11 may also automatically (or caused by the above-mentioned onetime actuating of the above-mentioned check key, e.g. the start/stop knob of the appliance 11) transfer the recorded moving images first—for instance, via Bluetooth or WiFi—to a mobile phone 14 of the respective user or to any other mobile phone, and from there on to the corresponding social networks, such as Youtube®, Facebook®, Instagram®, etc.

By actuating the above-mentioned check key, e.g. the start/stop knob of the appliance 11 again, the appliance 11 can initiate automatically that no more moving images are transferred to the above-mentioned servers 13 or the mobile phone 14 (and hence not to the above-mentioned social networks as well), and it can simultaneously be initiated automatically that an appropriate “stop recording signal” is sent by the appliance 11—e.g. via Bluetooth or WiFi—to the camera 12.

On receipt of this “stop recording signal” by the camera 12 it automatically initiates the stop of the recording of moving images and the stop of the transferring of moving images from the camera 12 to the appliance 11.

The operation of the system 10 in accordance with the invention for transferring or processing camera data (LIVEDOCK system 10) is thus substantially easier than with conventional systems.

In further, alternative embodiments of the system 10 (LIVEDOCK system 10) in accordance with the invention which has been explained above exemplarily by means of FIGS. 1 and 2, some or all of the above described and/or further functions assumed in the system 10 by the mobile appliance 11 may, instead by the mobile appliance 11, also be assumed by any other mobile appliance, for instance, the mobile phone 14 of the respective user, or any further mobile phone, or any other mobile or stationary device.

In further, alternative embodiments of the system 10 in accordance with the invention which has been explained above exemplarily by means of FIGS. 1 and 2, the mobile appliance 11 and the camera 12 may also be designed and configured such that the communication between them does not take place wirelessly, but completely or partially by wire, for instance, by means of a USB cable, e.g. a micro USB or USB-C cable between the mobile appliance 11 and the camera 12.

### LIST OF REFERENCE SIGNS (Re FIG. 1)

“1”: Connected via Bluetooth and WiFi and/or cable
“2”: LIVEDOCK starts the camera and/or live transfer
“3”: camera transfers per WiFi/BT and/or cable video to LIVEDOCK
“4”: Transfer of the videos per mobile radio (LTE) to back-end or dedicated server
“5”: Storing and/or forwarding of videos
“6”: Transfer of the videos in real time to social networks or other Internet addresses
“7”: Access to LIVEDOCK via application on mobile phone and/or computer
“8”: Access to back-end server with application via mobile or Internet

### LIST OF REFERENCE SIGNS (re FIG. 2)

### Livedock Appliance 11

Characteristics and dimensions

### Components:

on/off and start/stop knob
Switch modi (live and remote)
LEDs as a status indication
Battery 2,000 mAh
SIM card+eSIM
LTE+Bluetooth 5.0+WiFi installed
CPU and antennae installed
External display indication is possible
Further sensors are possible
Cable connections, e.g. micro-USB or USB-C connection

1. A system for transferring or processing camera data, comprising:
a camera for recording image data, and
a mobile device or mobile appliance which can communicate with the camera wirelessly or by wire for forwarding the image data to the Internet.

2. The system according to claim 1, wherein the mobile appliance is designed and configured such that the image data can be forwarded by the mobile appliance to social networks.

3. The system according to claim 1, wherein the image data is forwarded by the mobile appliance in real time.

4. The system according to claim 1, wherein the mobile appliance is not a mobile phone.

5. The system according to claim 1, wherein the mobile device is a mobile phone.

6. The system according to claim 1, wherein the mobile appliance is designed and configured such that it can be used to control one or more functions of the camera.

7. The system according to claim 1, wherein the mobile appliance forwards the image data via one or a plurality of servers or computers in which especially processing or editing of the image data may take place, in particular by using further image data recorded by one or a plurality of further cameras.

8. A method of transferring or processing of image data, comprising the steps of:
recording of image data by a camera; and
communicating the image data from the camera to a mobile device or a mobile appliance wirelessly or by wire for forwarding the image data to the Internet.

9. The method according to claim 8, wherein the mobile appliance forwards the image data via one or a plurality of servers or computers, and wherein the method additionally comprises the step of:
processing or editing the image data in the server(s) and/or computer(s), in particular by using further image data recorded by one or a plurality of further cameras.

10. A mobile device or mobile appliance according to claim 1 for use with a camera, which is designed and configured such that it can be used as a mobile device or mobile appliance in a system.

11. The system according to claim 2, wherein the image data are forwarded by the mobile appliance in real time.

12. The system according to claim 11, wherein the mobile device is a mobile phone.

13. The system according to claim 3, wherein the mobile device is a mobile phone.

14. The system according to claim 11, wherein the mobile appliance is designed and configured such that it can be used to control one or more functions of the camera.

15. The system according to claim 2, wherein the mobile appliance forwards the image data via one or a plurality of servers or computers in which especially processing or editing of the image data may take place, in particular by using further image data recorded by one or a plurality of further cameras.

16. The system according to claim 14, wherein the mobile appliance forwards the image data via one or a plurality of servers or computers in which especially processing or editing of the image data may take place, in particular by using further image data recorded by one or a plurality of further cameras.

17. A mobile device or mobile appliance according to claim 11 for use with a camera, which is designed and configured such that it can be used as a mobile device or mobile appliance in a system.

18. A mobile device or mobile appliance according to claim 8 for use with a camera, which is designed and configured such that it can be used as a mobile device or mobile appliance in a system.

19. A mobile device or mobile appliance according to claim 16 for use with a camera, which is designed and configured such that it can be used as a mobile device or mobile appliance in a system.

20. The system according to claim 11, wherein the mobile appliance is not a mobile phone.
